(19) United States
(12) Patent Application Publication
(10) Pub. No.: US 2009/0015548 A1
(43) Pub. Date: Jan. 15, 2009

(54) Image projection system

(76) Inventors: Keiko Tazaki, Chiba (JP); Runa Nakamura, Tokyo (JP); Satoko Maenishi, Saitama (JP)

Correspondence Address: SMITH PATENT OFFICE, 1901 PENNSYLVANIA AVENUE N W, SUITE 901, WASHINGTON, DC, 20006, US

(21) Appl. No.: 12/214,000

(22) Filed: Jun. 27, 2008

(30) Foreign Application Priority Data
Jun. 28, 2007 (JP) 2007-170875
Jul. 3, 2007 (JP) 2007-174815

(51) Int. Cl. G09G 5/00

(52) U.S. Cl. 345/156

(57) ABSTRACT

Provided is an image projection system including a screen, an input terminal, an image processing unit, an image projector, and invisible light ray-shielding member, characterized in that: the screen has a pattern-printed sheet having reflection patterns for transmitting positional information by reflecting invisible light rays or absorption patterns for transmitting positional information by absorbing invisible light rays; the input terminal has an invisible light ray-applying portion, detects a reflected light ray of an invisible light ray, which is applied from the invisible light ray-applying portion and reflected from a specific site of the pattern-printed sheet, reads positional information of any one of the reflection patterns or any one of the absorption patterns, and outputs the positional information to the image processing unit; the image processing unit converts the positional information input from the input terminal into image information A, and transfers the image information A to the image projector; the image projector converts the image information A transferred from the image processing unit into visible light rays, and projects the visible light rays on the screen; and the invisible light ray-shielding means is placed in front of or inside the image projector, and removes the invisible light ray from the visible light rays to be projected. The present invention can provide the image projection system in which, even when a screen is large, the positional information of the screen can be simply input in a non-contact fashion with high accuracy, and image information converted from the input positional information can be further converted into visible light rays to be projected.

### TECHNICAL FIELD

The present invention relates to an image projection system for continuously projecting static images and/or moving images on a screen.

### BACKGROUND ART

A projection system including a projection screen and a projector has been conventionally known, and various proposals concerning the system have been made (see, for example, Patent Documents 1 to 6).

In addition, Patent Document 7 proposes an optical projection system including means for generating a signal indicating the position of a hand-held pointer on a display screen, for example, a digitizer for specifying the x and y coordinates of the hand-held pointer.

However, an approach to interlocking the hand-held pointer and the digitizer requires the pointer to contact the screen, so the scope of applications of the projection system is limited, and the accuracy of acquired positional information is low.

[Patent Document 1] Japanese Patent Application Laid-open No. 2005-43712

[Patent Document 2] Japanese Patent Application Laid-open No. 2005-55887

[Patent Document 3] Japanese Patent Application Laid-open No. 2005-91744

[Patent Document 4] Japanese Patent Application Laid-open No. 2005-107083

[Patent Document 5] Japanese Patent Application Laid-open No. 2005-164708

[Patent Document 6] Japanese Patent Application Laid-open No. 2005-326824

[Patent Document 7] Japanese Patent Application Laid-open No. Hei 07-77953

### DISCLOSURE OF THE INVENTION

The present invention has been made with a view to solving the above problems, and an object of the present invention is to provide an image projection system having the following characteristics: even when a screen is large, the positional information of the screen can be simply input in a non-contact fashion with high accuracy, and image information converted from the input positional information can be further converted into visible light rays to be projected.

The inventors of the present invention have made extensive studies with a view to achieving the above object. As a result, the inventors have found that the above object can be achieved by improving a method of inputting positional information. Thus, the inventors have completed the present invention.

That is, the present invention provides an image projection system including a screen, an input terminal, an image processing unit, an image projector, and invisible light ray-shielding means, characterized in that:

the screen has a pattern-printed sheet having reflection patterns for transmitting positional information by reflecting invisible light rays or absorption patterns for transmitting positional information by absorbing invisible light rays;

the input terminal has an invisible light ray-applying portion, detects a reflected light ray of an invisible light ray, which is applied from the invisible light ray-applying portion and reflected from a specific site of the pattern-printed sheet, reads positional information of any one of the reflection patterns or any one of the absorption patterns, and outputs the positional information to the image processing unit;

the image processing unit converts the positional information input from the input terminal into image information A, and transfers the image information A to the image projector;

the image projector converts the image information A transferred from the image processing unit into visible light rays, and projects the visible light rays on the screen; and

the invisible light ray-shielding means is placed in front of or inside the image projector, and removes the invisible light ray from the visible light rays to be projected.

According to the present invention, there can be provided an image projection system having the following characteristics: even when a screen is large, the positional information of the screen can be simply input in a non-contact fashion with high accuracy, and image information converted from the input positional information can be further converted into visible light rays to be projected.

### BRIEF DESCRIPTION OF THE DRAWINGS

FIG. 1 is a block diagram showing an embodiment of an image projection system of the present invention.

FIG. 2 is an outline view of the entirety of the embodiment of the image projection system of the present invention.

FIG. 3 is a plan view showing, in an enlarged fashion, the main portion of a pattern-printed sheet to be used in the image projection system of the present invention in which dot-shaped reflection patterns are irregularly arranged.

FIG. 4 is a sectional view showing an embodiment of a pattern-printed sheet having a reflection pattern to be used in the image projection system of the present invention.

FIG. 5 is a sectional view showing another embodiment of the pattern-printed sheet having a reflection pattern to be used in the image projection system of the present invention.

FIG. 6 is a sectional view showing another embodiment of the pattern-printed sheet having a reflection pattern to be used in the image projection system of the present invention.

FIG. 7 is a sectional view showing an embodiment of a pattern-printed sheet having an absorption pattern to be used in the image projection system of the present invention.

FIG. 8 is a sectional view showing another embodiment of the pattern-printed sheet having an absorption pattern to be used in the image projection system of the present invention.

FIG. 9 is a sectional view showing another embodiment of the pattern-printed sheet having an absorption pattern to be used in the image projection system of the present invention.

FIG. 10 is a sectional view showing another embodiment of the pattern-printed sheet having an absorption pattern to be used in the image projection system of the present invention.

FIG. 11 is a sectional view showing another embodiment of the pattern-printed sheet having an absorption pattern to be used in the image projection system of the present invention.

### DESCRIPTION OF SYMBOLS

10: screen
11: pattern-printed sheet
20: input terminal
30: image processing unit
40: image projector
50: invisible light ray-shielding means
60: image source unit
70, 70′: cord
110: reflection pattern
120: substrate A
121: base material A
122: primer layer
123: orientation film
130: surface protective layer
210: absorption pattern
220: substrate B
230: liquid crystal layer
240: transparent base material B
250: light diffusion film
260: invisible light ray-reflecting layer
i: invisible light ray
r: reflected light ray

### BEST MODE FOR CARRYING OUT THE INVENTION

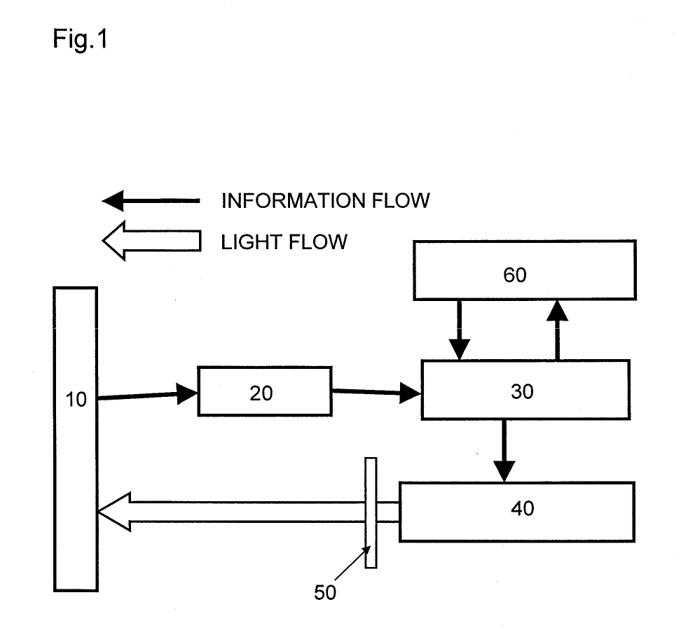

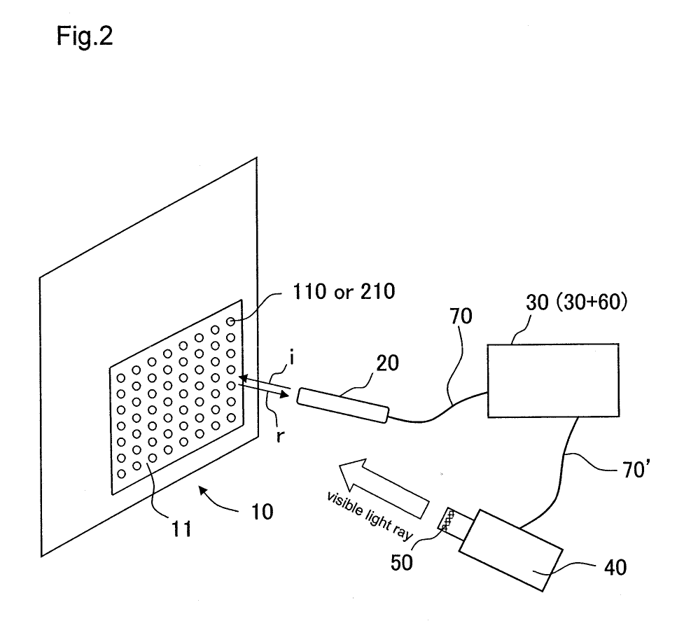

Hereinafter, the present invention will be described with reference to drawings. FIG. 1 is a block diagram showing an embodiment of an image projection system of the present invention. In addition, FIG. 2 is an outline view of the entirety of the embodiment of the image projection system of the present invention.

The image projection system of the present invention is an image projection system including: a screen 10; an input terminal 20; an image processing unit 30; an image projector 40; and invisible light ray-shielding means 50.

Here, the screen 10 is provided with a pattern-printed sheet 11 having reflection patterns 110 for transmitting positional information by reflecting invisible light rays or absorption patterns 210 for transmitting positional information by absorbing invisible light rays.

Then, the input terminal 20 is provided with an invisible light ray-applying portion (not shown). An invisible light ray i is applied from the invisible light ray-applying portion to a specific site of the pattern-printed sheet 11, and a reflected light ray r reflected from any one of the reflection patterns 110 of the sheet or a reflected light ray r reflected from the periphery of any one of the absorption patterns 210 of the sheet is incident on and detected by the input terminal 20. The input terminal 20 can receive the positional information of the absorption pattern 210 by the detection of the reflected light ray r reflected from the periphery of the absorption pattern 210 simultaneously with the reception of the positional information of the reflection pattern 110 by the detection of the reflected light ray r reflected from the reflection pattern 110.

The input terminal 20 reads the positional information of the reflection pattern 110 or of the absorption pattern 210 with the detected reflected light ray r, and outputs the positional information to the image processing unit 30 via, for example, a cord 70; provided that the cord 70 may be a wire cable or the like, or the positional information may be sent in a wireless fashion with, for example, an electric wave or an infrared ray.

It should be noted that the invisible light ray i according to the present invention is preferably an infrared ray or an ultraviolet ray, or more preferably a near infrared ray or a near ultraviolet ray.

The image processing unit 30 converts the positional information input from the input terminal 20 into image information A, and transfers the image information A to the image projector 40 via, for example, a cord 70′; provided that, as in the case of the cord 70, the cord 70′ may be a wire cable or the like, or the image information may be sent in a wireless fashion with, for example, an electric wave or an infrared ray.

The image projector 40 converts the image information A transferred from the image processing unit 30 into visible light rays, and projects the visible light rays on the screen 10; provided that, when the visible light rays to be projected include an invisible light ray X having a wavelength region overlapping the invisible light ray transmitted from the above invisible light ray-applying portion, it becomes difficult to read the above positional information, so the invisible light ray X must be removed and shielded from the visible light rays with the invisible light ray-shielding means 50 in advance prior to the projection. The invisible light ray-shielding means 50 may be placed independent of and in front of the image projector 40 as shown in FIG. 1, or may be placed in the image projector 40, for example, in front of (outside) the optical lens of the projector as shown in FIG. 2.

An observer (person responsible for the input of positional information) who viewed an image projected from the image projector 40 further inputs next positional information with the input terminal 20.

In the present invention, the pattern-printed sheet 11 which the screen 10 has may be placed over the entirety of the screen 10, or may be placed on part of the screen 10 as shown in FIG. 2.

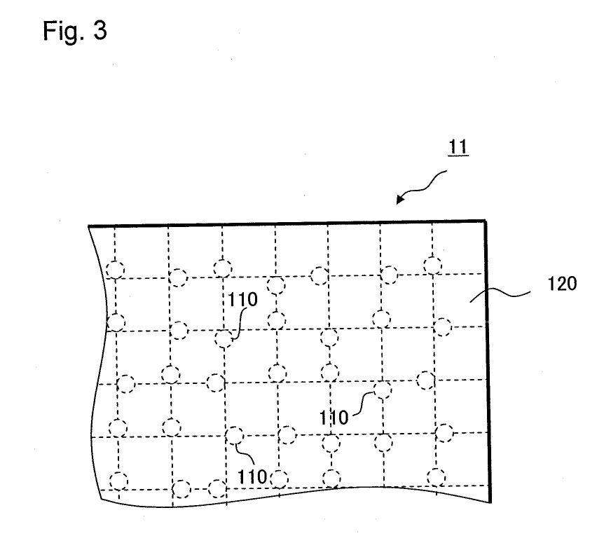

FIG. 3 is a plan view showing, in an enlarged fashion, the main portion of the pattern-printed sheet 11 to be used in the image projection system of the present invention in which the reflection patterns 110 of dot shapes are irregularly arranged. Although a plan view showing, in an enlarged fashion, the main portion of a pattern-printed sheet in which the absorption patterns 210 of dot shapes are irregularly arranged is not given, the absorption patterns 210 are arranged as in the case of the reflection patterns 110.

A method of arranging the reflection patterns 110 or the absorption patterns 210 according to the present invention has only to be set so that positional information on the surface of the pattern-printed sheet 11 can be derived from a partial pattern, which is read with the input terminal 20 provided with a sensor, through the input terminal 20. Such patterns may be irregularly arranged as shown in FIG. 3, or may be regularly arranged.

For example, in each of the method of arranging the reflection patterns 110 and the method of arranging the absorption patterns 210, any one of the following procedures is applicable: multiple dot shapes are set; and a combination of dots of the multiple shapes placed in a predetermined range in a plane is turned into a pattern; the thicknesses of ruler lines placed in a crisscross fashion are changed, and a combination of the sizes of the overlapping portions of the ruler lines in a predetermined range is turned into a pattern; or values for x and y coordinates are directly associated with the vertical and horizontal sizes of a dot. It should be noted that a particularly simple and suitable method is, for example, as follows: reference points arranged at a regular interval in a crisscross fashion are set, dots displacing vertically and horizontally relative to the reference points are placed, and the positional relationships of these dots relative to the reference points are utilized. The method is advantageous for an increase in resolution of an input apparatus because the method allows the sizes of the dots to be made small and constant. As described above, the reflection patterns 110 and the absorption patterns 210 are preferably of dot shapes. The respective dot shapes are arbitrary, and the shapes when viewed from above are each selected from a circular shape, an elliptic shape, a square shape, a rectangular shape, a polygonal shape, and any other dot shape as desired. The size of each dot in a plane (the dot is evaluated for its size in a plane on the basis of a diameter/a longitudinal diameter/the diameter of a circumscribed circle when the dot is of a circular shape/an elliptic shape/a polygonal shape) is about 10 to 1,000 μm. The stereoscopic shape of each dot, which is typically a disk-like shape, is not particularly limited either, and may be a hemispherical shape, an elliptic hemispherical shape, a columnar shape, or a concave shape.

The input terminal 20 to be used in the image projection system of the present invention is provided with the invisible light ray-applying portion for applying the invisible light ray i having a predetermined wavelength and the sensor for detecting the reflected light ray r. The input terminal 20 images, for example, positional information from the reflected light ray r detected with the sensor as a pattern (the pattern imaging is performed, for example, about several tens of times to 100 times per second) so as to allow one to recognize the positional information as image information. When the input terminal 20 is provided with a read data processing apparatus (not shown), the terminal analyzes the imaged pattern with the processor to digitize, and turn into data, an input path in association with the movement of the invisible light ray-applying portion at the time of handwriting so that input path data is produced. The terminal sends the input path data to the image processing unit 30.

It should be noted that members such as a processor, a memory, a communication interface such as a wireless transceiver utilizing the Bluetooth technique or the like, and a battery may be placed outside the input terminal 20, or may be built in the image processing unit 30.

The input terminal 20 may be of an arbitrary shape, and examples of the shape include a pen shape, a cylindrical shape, a pistol shape, and a pointer shape; the terminal preferably has a light weight so as to be capable of showing positional information in a non-contact fashion with high accuracy.

The read data processing apparatus to be built in the input terminal 20 or the image processing unit 30 described above, or the read data processing apparatus to be built in a midpoint between them is not particularly limited as long as the processing apparatus has the following function: the processing apparatus calculates positional information from continuous imaging data read with the sensor of the input terminal 20, and combines the positional information with time information as required to provide the resultant as input path data that can be handled with the image processing unit 30. The processing apparatus has only to be provided with members such as a processor, a memory, a communication interface, and a battery. The read data processing apparatus is preferably built in the image processing unit 30 in order that the weight of the input terminal 20 may be reduced, or information processing may be performed integrally with various kinds of image processing.

The image processing unit 30 to be used in the image projection system of the present invention converts the positional information input from the input terminal 20 via the read data processing apparatus into the image information A, and transfers the image information A to the image projector 40.

Here, the image information A is not limited to various kinds of image information including characters, symbols, numbers, figures, codes such as a barcode, and photographic images (such as a landscape image, a person image, a drawing image, and other various images), and may be command information for commanding the projection of any other static image or moving image. Any one of the various kinds of image information corresponds to the case where the path of the invisible light ray applied from the invisible light ray-applying portion of the input terminal 20 directly represents a character, a symbol, or a drawing. The command information corresponds to, for example, the case where a program is set in advance so that the reflected light ray r from a specific site of the pattern-printed sheet 11 represents a specific character, symbol, or drawing. Of course, the image information A may be provided with both image information and command information.

The image processing unit 30 sequentially updates image information to be displayed on the screen 10 on the basis of path information sent from the read data processing apparatus, whereby a path input by handwriting with the input terminal 20 can be displayed on the screen 10 in a real time fashion (or, if required, with an appropriate delay time) as if the path were written on paper with a pen.

The image projector 40 to be used in the image projection system of the present invention converts the image information A transferred from the image processing unit 30 into visible light rays, and projects the visible light rays on the screen 10. Various commercially available projectors are each suitably used as the image projector 40, and examples of the projectors include a CRT projector, a digital light processing (DLP) projector, a liquid crystal projector, a liquid-crystal-on-silicon (LCOS) projector, and a grating light valve (GLV) projector.

The invisible light ray-shielding means shields an invisible light ray by absorbing or reflecting the ray. For example, a commercially available invisible light ray-shielding film (such as an infrared ray-shielding film or an ultraviolet ray-shielding film) is appropriately used.

The image projection system of the present invention is preferably further provided with an image source unit 60 for reading and transferring image data. In this case, the image processing unit 30 can convert positional information into the image information A, and, at the same time, can convert the image data transferred from the image source unit 60 into image information B.

Here, the image information B is image information about something different from that indicated by the image information A, and comprehends various kinds of image information including characters, symbols, numbers, figures, codes such as a barcode, photographic images (such as a landscape image, a person image, a drawing image, and other various images), and moving images such as a movie (including animation).

The image source unit 60 reads the image data of a recording medium such as a DVD, a hard disk, a CD, or a video, or image data delivered from a wireless or wired base station, and transfers the data to the image processing unit 30.

Parallel processing of the image information A and the image information B provides an additionally sophisticated projection system.

For example, the image information A functions as command information for commanding the conversion of image data into an image, and the image processing unit 30 converts the image data into the image information B in accordance with the command of the image information A, whereby an image to be projected can be freely controlled.

In addition, the image processing unit 30 compounds the image information A and the image information B into composite image information, whereby a composite image can be projected.

For example, a projected image such as a handwritten character, symbol, or number derived from the image information A is incorporated into a projected image derived from the image information B, whereby the value of the information can be increased.

Further, the image information A can bring together both such command information as described above and information about, for example, an image such as a handwritten character, symbol, or number.

In the image projection system of the present invention, the image information A and/or the image information B are each preferably/is preferably streaming information because of the following reasons: in a streaming technique, one can project contents such as a moving image immediately after the initiation of the reception of image data about the contents without waiting for the completion of the downloading of the image data, and there is no need to store large-size contents data.

The streaming information in the present invention comprehends not only a moving image but also such an image that part of a moving image is static images and the static images are continuously projected as an image stream and such an image that static images are continuously projected as an image stream.

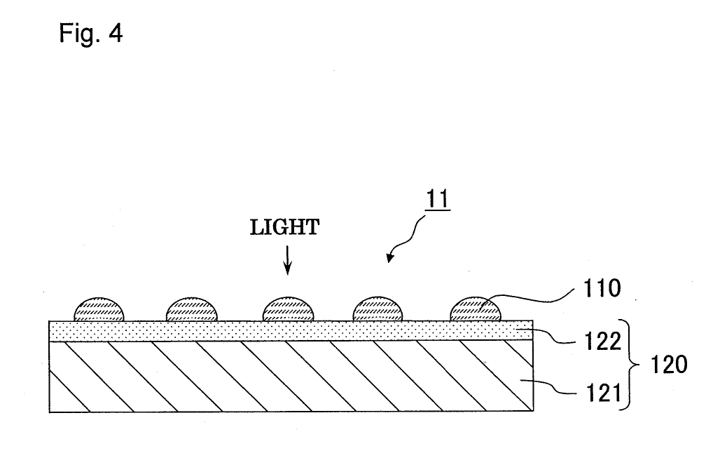

FIGS. 4 to 6 are sectional views showing one and other embodiments of the pattern-printed sheet 11 having the reflection patterns 110 to be used in the image projection system of the present invention.

As shown in each of FIGS. 4 to 6, the pattern-printed sheet 11 is obtained by providing the reflection patterns 110 on a substrate A 120 according to any one of the above-mentioned arrangements by printing and applying means such as gravure printing.

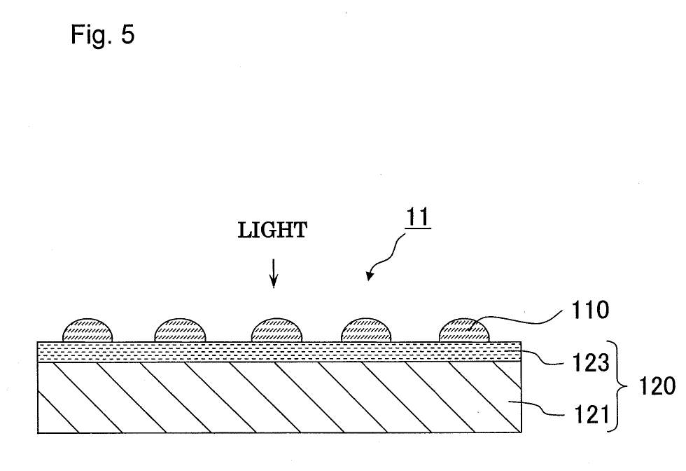

The substrate A 120 may be a base material A 121 itself, may be one obtained by applying a primer layer 122 onto the base material A 121 as shown in FIG. 4, or may be one obtained by applying an orientation film 123 onto the base material A 121 as shown in FIG. 5.

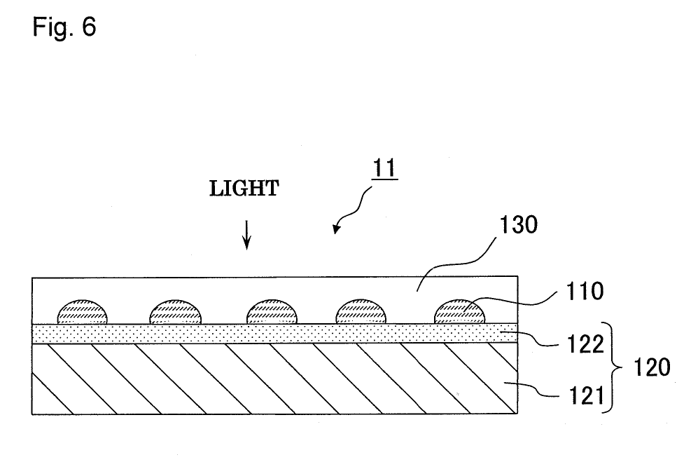

In addition, a surface protective layer 130 that covers the reflection patterns 110 may be provided for protecting the reflection patterns 110 as required as shown in FIG. 6.

In the present invention, an invisible light ray-reflecting material of which each of the reflection patterns 110 is formed is, for example, an infrared ray-reflecting material or an ultraviolet ray-reflecting material.

A known material can be used as the infrared ray-reflecting material as long as the material shows a desired reflectivity at a target wavelength. For example, a white pigment or metal powder pigment showing heat ray-reflecting performance and having a high reflectivity for sunlight, specifically, an inorganic powder made of titanium oxide (TiO₂), zinc oxide, zinc sulfide, lead white, antimony oxide, zirconium oxide, tin oxide, or a composite metal oxide such as tin-doped indium oxide (ITO) or tin-doped antimony oxide, or a metal powder made of aluminum, gold, copper, or the like is preferably used. Calcium carbonate, barium sulfate, silica, alumina (Al₂O₃), clay, talc, or the like is also available.

In addition, antimony trioxide and antimony dichromate that have infrared ray- and far-infrared ray-reflecting performance and heat ray-reflecting performance, and inorganic powders such as SiO₂ (quartz), Al₂O₃ (alumina), MgO—Al₂O₃—SiO₂ (cordierite), Ca₂P₂O₇ (apatite), MnO₂, Fe₂O₃, ZrO₂, ZrSiO₄ (zircon), FeTiO₃ (ilmenite), Cr₂O₃, FrCr₂O₄ (chromite), V₂O₅, Bi₂O₃, MoO₃, SnO₂, ZnO, ThO₂, La₂O₃, CeO₂, Pr₆O₁₁, Nd₂O₃, and Y₂O₃ are preferably used in a case where those exhibit desired reflectivity at a target wavelength.

In addition, for example, an interference pigment composed of a transparent supporting material such as natural or synthetic mica, another leaf-like silicate, a glass flake, flaky silicon dioxide, or aluminum oxide and a metal oxide coating described in Japanese Patent Application Laid-open No. 2004-4840 can also be used.

In addition, a complex metal oxide including plural kinds of the above components may be used. Specifically, as commercially available inorganic infrared ray-reflecting material, materials that have desired reflectivity at a target wavelength and are selected from Yellow 10401, Yellow 10408, Brown 10348, Green 10405, Blue 10336, Brown 10364, Brown 10363 (all of which are product names; manufactured by CERDEC), AB820 Black, AG235 Black, AY150 Yellow, AY610 Yellow, AR100 Brown, AR300 Brown, AA200 Blue, AA500 Blue, AM110 Green, (all of which are product names; manufactured by KAWAMURA CHEMICAL CO., LTD.), Pigment Black 28 (CuCr₂O₄), Pigment Black 27 {(Co, Fe) (Fe, Cr)₂O₄}, and Pigment Green 17 (Cr₂O₃) (all of which are product names; manufactured by TOKAN KOGYO CO., LTD.) are preferably used.

Of those, particularly, AB820 Black, AG235 Black, Pigment Black 28, and Pigment Black 27 are preferred.

In addition, examples of the ultraviolet ray-reflecting material include oxides of titanium, zirconium, zinc, indium, tin, and the like, a sulfide of zinc, and nitrides of silicon, boron, and the like.

Upon preparation of ink by using the invisible light ray-reflecting material, a dispersant may be used for improving the dispersing performance of the material. The kind of the dispersant is not particularly limited, and a known dispersant has only to be used. A commercially available dispersant is specifically, for example, a DISPERBYK 183, 110, 111, 116, 140, 161, 163, 164, 170, 171, 174, 180, 182, 2000, 2001, or 2020 (tradename; manufactured by BYK-Chemie GmbH).

It should be noted that the dispersant is used in an amount of preferably 1 to 50 parts by weight with respect to 100 parts by weight of the material.

Of the above-mentioned invisible light ray-reflecting materials, titanium oxide is preferable because it can be used as each of an infrared ray-reflecting material and an ultraviolet ray-reflecting material. Titanium oxide may be of each of a rutile type and an anatase type. Titanium oxide having an average particle diameter of about 0.1 to 0.5 μm is typically used. In addition, the surface of titanium oxide is preferably treated with a metal oxide. Here, a metalloid such as arsenic, antimony, bismuth, silicon, germanium, boron, tellurium, or polonium is also included in the category of the metal of the metal oxide. Silica or alumina is typically used as the metal oxide; silica is preferable.

A resin composition in which the above invisible light ray-reflecting material is dispersed and incorporated is suitably used as a resin composition for an ink of which each of the reflection patterns 110 is formed. A binder resin to be used in the resin composition is, for example, any one of various thermoplastic, thermosetting, photo-curable, and electron ray-curable resins. Examples of the binder resin include a polyester resin, a urethane resin, an acrylic resin, an epoxy resin, a vinyl chloride-vinyl acetate copolymer, and a mixture of two or more kinds selected from them. Of those, the urethane resin is preferable.

Specific examples of the urethane resin include urethane resins such as polyester polyurethane, polyether polyurethane, polyether polyester polyurethane, polycarbonate polyurethane, and polycaprolactam polyurethane, and mixtures thereof.

The urethane resin is obtained by allowing a polyisocyanate compound and a polymer polyol to react with each other by a known method such as a solution polymerization method, and as required, adding a chain extender and a reaction terminator to the urethane prepolymer.

The polyisocyanate compound may be one used in production of conventional urethane resin. Examples of the polyisocyanate compound include: aliphatic isocyanates such as 1,6-hexamethylene diisocyanate, methylene diisocyanate, trimethylene diisocyanate, 2,2,4- or 2,4,4-trimethyl hexamethylene diisocyanate, tetramethylene diisocyanate, 1,2-propylene diisocyanate, isopropylene diisocyanate, and 1,3-butylene diisocyanate; alicyclic isocyanates such as 1,3- or 1,4-cyclohexane diisocyanate, isophorone diisocyanate, 1,3-bis(isocyanate methyl)cyclohexane, and methyl-2,6-cyclohexane diisocyanate; aromatic isocyanates such as m- or p-phenylenediisocyanate, 4,4-diphenylmethane diisocyanate, 2,4- or 2,6-tolylene diisocyanate, and naphthylene diisocyanate.

In addition, examples of the polymer polyol to be reacted with the polyisocyanate compound include polyester polyols such as saturated hydrocarbon-based polyester polyol, polyether polyol, and polyetherester polyol.

Examples of the polyester polyol include polyester polyols formed of a polyvalent carboxylic acid and a polyvalent alcohol and polyester polyols obtained by ring-opening polymerization of lactone rings. Examples of the polyvalent carboxylic acid include: aliphatic polyvalent carboxylic acids such as a linear saturated hydrocarbon-based adipic acid, azelaic acid, succinic acid, and sebacic acid; unsaturated aliphatic polyvalent carboxylic acids such as an unsaturated fatty acid-based fumaric acid and maleic acid; alicyclic polyvalent carboxylic acids such as 1,4-cyclohexane dicarboxylic acid having a cyclohexyl group; aromatic polyvalent carboxylic acids such as phthalic acid, isophthalic acid, and terephthalic acid.

Examples of the polyvalent alcohols to be reacted with the polyvalent carboxylic acid include polyalent alcohols of aliphatic or alicyclic such as ethylene glycol, diethylene glycol, 1,3-propylene glycol, dipropylene glycol, neopentyl glycol, triethylene glycol, xylylene glycol, polyethylene glycol, 1,2- or 1,3-propanediol, 1,2-, 1,3-, and 1,4-butanediol, and 1,5-pentanediol, and aromatic polyvalent alcohols.

In addition, examples of the polyether polyol include polyether polyols obtained by polymerizing an oxirane compound such as ethylene oxide or propylene oxide using a polyvalent alcohol such as ethylene glycol, 1,2-propanediol, or glycerine as a polymerization initiator. In addition, examples of the polyetherester polyol include polyetherester polyols obtained by allowing the polyether polyol to react with the polyvalent carboxylic acid.

The chain length of the urethane resin is preferably adjusted by using, in addition to the polyisocyanate compound and the polymer polyol, alcohols such as ethylene glycol, diethylene glycol, and 1,2-propanediol, amines such as ethylene diamine and propylene diamine as a chain extender, and a known lower alcohol-based or amine-based chain extending terminator.

The resin component may be used alone or plural kinds of resin components may be used in mixture. Besides, in order to improve tearing property of the base material coated with a white coat, a curing agent may be added to the resin component. Examples of the curing agent include the above-mentioned aliphatics having a plural isocyanate groups, and polyisocyanate compounds of alicyclics and aromatics, and polyisocyanate compounds other than those compounds, such as tolylene diisocyanate, hexamethylene diisocyanate, triphenylmethane triisocyanate, diphenylmethane diisocyanate, o-toluidine diisocyanate, isophorone diisocyanate, 1,3,5-triisocyanate methylbenzene, and lysineester triisocyanate, and polymers such as dimers and trimers derived from those isocyanate compounds, and polyisocyanate obtained by a reaction between an isocyanate compound and a polyol compound such as 3,3,3-trimethylolpropane.

Preferable examples of the curing agent include a trimer of hexamethylene diisocyanate, a reaction product of 3,3,3-trimethylolpropane and hexamethylene diisocyanate, and a reaction product of 3,3,3-trimethylolpropane and tolylene diisocyanate. As the curing agent, TAKENATE D-110N available from MITSUI CHEMICALS POLYURETHANES, INC. can be used in the present invention.

When the above curing agent is used, the usage of the agent is preferably such that the agent is blended at a ratio of 0.8 to 10 wt % with respect to the resin component. When the compounding ratio of the above curing agent is excessively large, the resultant white coating film becomes brittle.

The resin component, which can be used alone, is preferably incorporated in such an amount as to account for 90 wt % to 100 wt % of the total amount of the resin composition. A compounding ratio of the above resin component lower than the above lower limit is not preferable because the tearing performance of the base material on which the resultant white coating film is formed reduces.

A resin component compatible with the above resin component such as a cellulose derivative such as nitrocellulose, cellulose propionate, cellulose acetate butyrate, cellulose diacetate, or cellulose triacetate, an alkyd resin, an acrylonitrile-butadiene copolymer, polyvinyl butyral, a styrene-butadiene copolymer, a polyester resin, or an epoxy resin can be used in the formulation of the resin component to such an extent that an object of the present invention is not impaired.

The above preferable white pigment composition containing titanium oxide is obtained by dispersing and kneading uniformly by a known method for uniformizing the resin component as a binder resin and titanium oxide into an organic solvent, for example, an alcohol such as isopropyl alcohol or normal propyl alcohol, an ester such as methyl acetate, ethyl acetate, butyl acetate, propyl acetate, ethyl lactate, or ethylene glycol acetate; a ketone such as methyl ethyl ketone, methyl isobutyl ketone, or cyclohexanone; an ether such as diethylene glycol methyl ether, tetrahydrofuran, ordioxane; and an aromatic such as toluene or xylene, a solvent such as halogenated hydrocarbons, or a mixture solvent thereof. An additive agent such as a plasticizer or a dispersant may be added as required as long as the object of the present invention is not impaired.

In addition, the white pigment composition may be provided with a desired color except a white color by adding a colorant as required; the color of the composition to be used is preferably a white color in order that the visibility of a display medium such as a screen may be improved.

An ink for pattern formation composed of the above-mentioned white pigment composition is an excellent diffusing ink for diffusing and reflecting invisible light rays over a wide range. The inventors of the present invention have been able to achieve the expansion of a reading angle with an input terminal such as a pen type sensor to about 70° by using the diffusing ink. The principle on which the diffusing ink diffuses invisible light rays is such that light is diffused by utilizing: the scattering of reflected light utilizing irregularities formed on the surface of a resin by the dispersion of particles in the resin; and internal scattering due to a difference in refractive index between the particles in the resin. A typical antiglare (AG) film transmits and diffuses incident light because the film is composed only of a binder resin and silica particles; titanium oxide is further introduced into the diffusing ink so that the ink shows opacifying performance, and obtains additionally high diffusion reflecting performance.

Next, an invisible light ray-reflecting material having high wavelength-selective reflecting performance of which each of the reflection patterns 110 is constituted is, for example, a reflecting material that reflects one of a left-handed circularly polarized light component and a right-handed circularly polarized light component for incident light rays (such property is called “circularly polarized light-selective reflecting performance”). Then, the resin composition as an invisible light ray-reflecting material of which each of the reflection patterns 110 is formed preferably transmits a visible light ray while reflecting an invisible light ray (such property is called “circularly polarized light-selective reflecting performance”). Further, the reflection patterns 110 are preferably capable of providing the positional information of an input terminal capable of applying and detecting invisible light rays on a pattern-printed sheet by reading the reflection patterns of the invisible light rays with the input terminal.

In addition, the reflection patterns 110 are preferably formed so as to include a multilayer structure having a certain cycle period when the sections of the formed reflection patterns 110 cut along a surface perpendicular to the substrate A 120 are observed with a scanning electron microscope. The multilayer structure is more preferably formed of a liquid crystal material having an immobilized cholesteric structure.

Here, a liquid crystal having a levorotatory or dextrorotatory cholesteric (chiral nematic) structure has a spiral structure (cholesteric structure) with a certain period having the following characteristics: the axes of the respective liquid crystal molecules are present in each layer surface of the multilayer structure and are uniformly oriented toward a specific direction in the layer surface; and the direction in which the axes of the liquid crystal molecules are oriented sequentially changes as a function of a layer thickness direction, and the axes sequentially rotate toward the thickness direction of the cholesteric structure, whereby the rotation axes are directed toward the thickness direction of the multilayer film and rotate toward a specific direction in the layer surface of the multilayer film. The cholesteric structure has the following characteristics: circularly polarized light-selective reflecting performance with which only a circularly polarized light component in which the rotation direction of the spiral and the rotation direction of an electric field rotates coincide with each other is reflected and wavelength-selective reflecting performance with which circularly polarized light having a wavelength corresponding to the pitch of the spiral is reflected. Accordingly, the cholesteric structure is suitable for the applications of the present invention. A selective reflection wavelength λ (nm) is generally given by the following equation. The cholesteric structure has such property that circularly polarized light having a wavelength corresponding to the orientation of the rotation axes and the spiral pitch is reflected (selective reflection). The selective reflection wavelength λ (nm) is generally given by the following equation:

λ=p·n·cos θ

where p represents the spiral pitch (nm) of the cholesteric liquid crystal, n represents the average refractive index of the liquid crystal, and θ represents the incident angle of light (angle from the normal of the surface of the liquid crystal).

One pitch of the cholesteric structure refers to a length in the direction of a helical axis needed for the axial direction of an elongated liquid crystal molecule to rotate by 360° while drawing a spiral along the layer thickness direction (corresponding to the helical axis and different from the axis of the liquid crystal molecule). However, when the section of the cholesteric structure is actually observed, a repeating layer structure is observed in the layer thickness direction because the direction in which the axis of a liquid crystal molecule is orientated in the layer surface returns to the original direction every time the axis of the liquid crystal molecule rotates by 180°. Therefore, an apparent interlayer pitch when the section is observed is one half of the spiral pitch of the liquid crystal. Accordingly, the pitch of the liquid crystal is 500 nm in the case where the apparent interlayer pitch when the section is observed is 250 nm.

In addition, when circularly polarized light is incident, the direction in which the circularly polarized light component of light to be reflected at the surface of a transparent base material composed of a typical substance such as a resin or glass rotates is reversed. On the other hand, the direction in which the circularly polarized light component of light to be reflected at the surface of a cholesteric liquid crystal rotates remains unchanged. Accordingly, the utilization of the foregoing property in combination with a circularly polarizing filter or the like can improve an S/N ratio between reflected light from an invisible light ray-reflective reflection pattern and the background light of the pattern (reflected light from a portion except the pattern portion).

It should be noted that, in general, the term “liquid crystal” strictly refers to one in a state of having flowability, but, in the description of the invention of the application, one obtained by bringing a liquid crystal material having flowability into a non-flowable state through the solidification of the material by a method such as crosslinking or cooling while desired performance which a liquid crystal has such as an optical characteristic, a refractive index, or anisotropy is maintained is also referred to as “liquid crystal”

Hereinafter, a liquid crystal material that expresses a cholesteric structure to be used in each of the reflection patterns 110 according to the present invention will be described. It should be noted that, although the wavelength of an invisible light ray is not particularly limited in the present invention, light in a near infrared region from 800 to 2,500 nm is particularly preferably used as an infrared ray out of the invisible light rays in ordinary cases, and light in a near ultraviolet region from 200 to 400 nm is particularly preferably used as an ultraviolet ray out of the invisible light rays in ordinary cases.

Each of a near infrared ray having a wavelength of 800 to 2,500 nm and a near ultraviolet ray having a wavelength of 200 to 400 nm will be a focus of the following description. By the way, in the description, the term “visible light ray” means a light ray in a visible wavelength region, specifically, 380 to 780 nm, and the term “transparent” means that a transmittance for light in the visible light ray region is high, specifically, the transmittance for light in the visible light ray region is about 50% or more, or more preferably 70% or more.

The invisible light ray-reflecting material of which each of the reflection patterns 110 is constituted to be used in the present invention is preferably a liquid crystal material showing a cholesteric liquid crystal phase having cholesteric regularity, and a polymerizable chiral nematic liquid crystal material (polymerizable monomer or polymerizable oligomer) obtained by mixing a polymerizable nematic liquid crystal having a crosslinkable functional group with a polymerizable chiral agent having a crosslinkable functional group, or a polymer cholesteric liquid crystal material can be suitably used. The polymerizable chiral nematic liquid crystal material is solidified (cured) by polymerization as a result of the occurrence of, for example, a crosslinking reaction by a known approach such as the application of ionizing radiation such as an ultraviolet ray or an electron ray, or heating.

In the present invention, a crosslinkable polymerizable monomer or crosslinkable polymerizable oligomer having a crosslinkable functional group in any one of its molecules out of the polymerizable liquid crystal materials is preferably used, and such monomer or oligomer more preferably has an acrylate structure as a polymerizable functional group.

It should be noted that the liquid crystal material showing (expressing) a cholesteric structure is not necessarily requested to show a high transmittance for light having a wavelength in the visible light ray region in essence as long as the material shows a high reflectivity for light having a wavelength in at least part of an invisible light ray region (about 5 to 50% for unpolarized light in ordinary cases). This is because, even when the liquid crystal material showing a cholesteric structure is completely opaque, the entirety of the reflection patterns can obtain desired transparency by utilizing transmitted light from a portion where the liquid crystal material is not formed (margin portion) as long as the area of the portion is moderately large; provided that it is of course preferable that the liquid crystal material itself have a high visible light ray transmittance. In addition, in the case where a wavelength region in which such liquid crystal material showing a cholesteric structure shows a high reflectivity is shifted toward the invisible light ray region, the material typically obtains a visible light ray transmittance of about 70% or more in the visible light ray region even when the thickness of the material is about several micrometers. On the other hand, the material generally obtains a reflectivity as high as about 5 to 50% for unpolarized light in the invisible light ray region. In addition, the temperature range in which the polymerizable liquid crystal material shows a cholesteric phase is not particularly limited, and the material has only to be immobilized by crosslinking while being in the state of a cholesteric phase; a material showing a cholesteric phase in the temperature range of 30 to 140° C. is preferable because a drying step at the time of pattern printing and the phase transition of a liquid crystal can be simultaneously performed.

In the case of such material as described above, liquid crystal molecules can be optically immobilized while being in the states of cholesteric liquid crystals, so patterns which can be easily handled as the pattern-printed sheet 11 and are stable at normal temperature can be formed.

A liquid crystal polymer (polymer cholesteric liquid crystal) which has a high glass transition point and can be solidified so as to be in a glass state at normal temperature by cooling after heating can also be used because of the following reason. In the case of such material as well, liquid crystal molecules can be optically immobilized while being in the states of liquid crystals each having cholesteric regularity, so patterns which can be easily handled as an optical sheet and are stable at normal temperature can be formed.

Such mixture of a liquid crystalline monomer and a chiral compound as disclosed in any one of Japanese Patent Application Laid-open No. Hei 7-258638, Japanese Patent Translation Publication No. Hei 11-513019, Japanese Patent Translation Publication No. Hei 9-506088, and Japanese Patent Translation Publication No. Hei 10-508882 can be used as the crosslinkable polymerizable monomer. For example, the addition of a chiral agent to a liquid crystalline monomer showing a nematic liquid crystal phase results in a chiral nematic liquid crystal (cholesteric liquid crystal). It should be noted that a method of forming a cholesteric liquid crystal into a film is described in each of Japanese Patent Application Laid-open No. 2001-5684 and Japanese Patent Application Laid-open No. 2001-110045 as well.

Examples of the nematic liquid crystal molecule (liquid crystalline monomer) that can be used in the present invention include compounds represented by the following formulae (1) to (11). Each of the compounds exemplified here has an acrylate structure, and can be polymerized by, for example, the application of an ultraviolet ray.

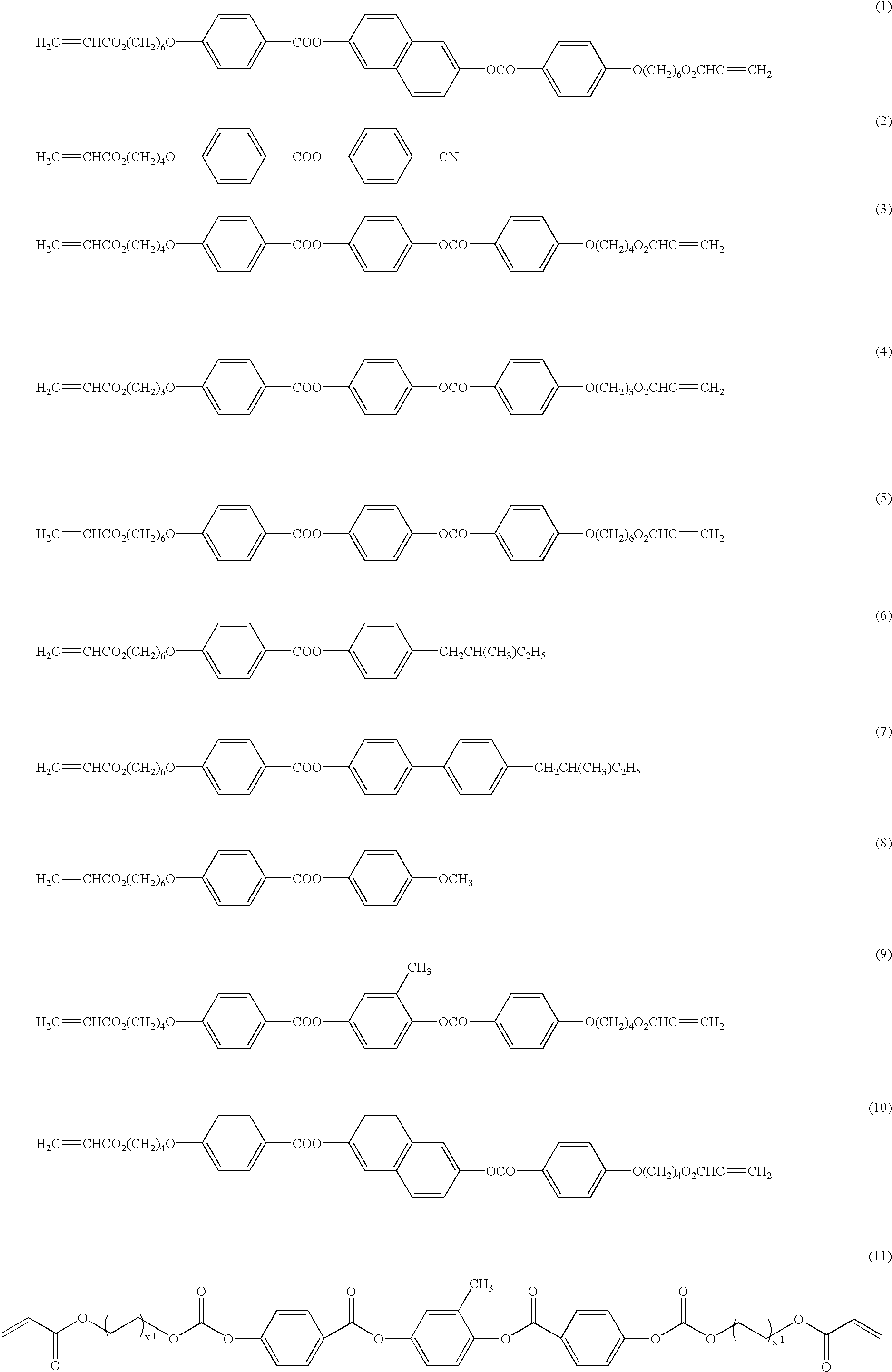

[In the compound (11), X¹ represents an integer of 2 to 5.]

In addition, for example, such cyclic organopolysiloxane compound having a cholesteric phase as disclosed in Japanese Patent Application Laid-open No. Sho 57-165480 can be used as the crosslinkable polymerizable oligomer.

Further, a polymer having a mesogen group showing liquid crystallinity introduced to its main chain, any one of its side chains, or each of both its main chain and any one of its side chains, a polymer cholesteric liquid crystal having a cholesteryl group introduced to any one of its side chains, such liquid crystalline polymer as disclosed in Japanese Patent Application Laid-open No. Hei 9-133810, such liquid crystalline polymer as disclosed in Japanese Patent Application Laid-open No. Hei 11-293252, or the like can be used as the liquid crystal polymer.

A chiral agent in an ink using the liquid crystal material according to the present invention is a material which has an asymmetric carbon atom and forms a chiral nematic phase by being mixed with a nematic liquid crystal, and is not particularly limited as long as the agent has polymerizability. Such material having an acrylate structure as exemplified in a formula (12) is preferable because the material can be polymerized by the application of an ultraviolet ray.

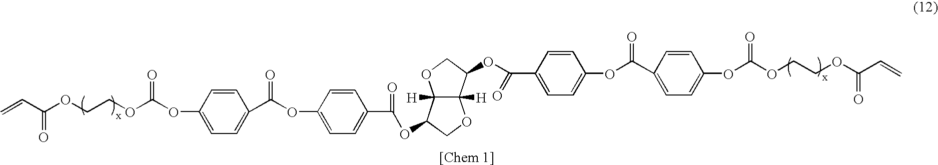

[X represents an integer of 2 to 5.]

In the present invention, the property with which an invisible light ray is reflected when a liquid crystal material is used in each of the reflection patterns 110 is preferably one utilizing the wavelength-selective reflecting performance of a liquid crystal material having a cholesteric structure (the same principle as that of the Bragg reflection in X-ray diffraction) as described above. The selective reflection peak wavelength (wavelength at which conditions for the Bragg reflection are satisfied) of the material is determined by the pitch length of the cholesteric structure in each of the patterns; a spiral pitch length can be controlled by adjusting the addition amount of a chiral agent when a nematic liquid crystal and the chiral agent are used as liquid crystal materials. The addition amount of a chiral agent for obtaining a target selective reflection peak wavelength in the invisible light ray region varies depending on the kind of a liquid crystal to be used and the kind of the chiral agent. For example, when the liquid crystal represented by the formula (11) and the chiral agent represented by the formula (12) are used, a cholesteric phase having a reflection peak in an infrared region is formed by the addition of about 3 parts by weight of the chiral agent to 100 parts by weight of the liquid crystal, and a cholesteric phase having a reflection peak in an ultraviolet region is formed by the addition of about 9 parts by weight of the chiral agent to 100 parts by weight of the liquid crystal. When a polymer cholesteric liquid crystal is used as a liquid crystal material, a polymer material having a target pitch length has only to be selected.

A reflection pattern using a liquid crystal material obtained as described above preferably has a selective reflection peak wavelength in the range of 800 nm to 950 nm or 200 to 400 nm from the viewpoint of an improvement in reading accuracy.

A polymer of the nematic liquid crystal molecule and the chiral agent described above can be obtained by, for example, adding a known photopolymerization initiator or the like to a polymerizable nematic liquid crystal and a polymerizable chiral agent and subjecting the mixture to radical polymerization by the application of an ultraviolet ray to the mixture.

Examples of the photopolymerization initiator include bisacylphosphine oxide-based or α-aminoketone-based photopolymerization initiators. Specific examples of the bisacylphosphine oxide-based photopolymerization initiator include diphenyl-(2,4,6-trimethylbenzoyl)phosphineoxide and bis(2,4,6-trimethylbenzoyl)phenylphosphine oxide. Specific examples of the α-aminoketone-based photopolymerization initiator include 2-methyl-1[4-(methylthio)phenyl]-2-morpholinopropane-1-one.

In addition, in the present invention, when each of reflection patterns 110 is printed with a liquid crystal material, a coating solution in which a polymerizable monomer and a polymerizable oligomer or a chiral agent is dissolved in a solvent is preferably used.

The solvent is not particularly limited, and a known solvent may be used as long as the solvent has sufficient solubility to the material. Examples of the solvent include general solvents such as anone(cyclohexane), cyclopentanone, toluene, acetone, methyl ethyl ketone (MEK), methyl isobutyl ketone (MIBK), N,N-dimethyl formamide (DMF), N,N-dimethylacetamide (DMA), methyl acetate, ethyl acetate, n-butyl acetate, and 3-methoxybutyl acetate, and mixed solvents thereof.

In the present invention, the substrate A 120 to be used in the pattern-printed sheet 11 having the reflection patterns 110 preferably transmits an invisible light ray.

Therefore, the base material A 121, which is not particularly limited, is preferably a material that transmits an invisible light ray, and is preferably formed of a material having a small number of optical discrepancies. A product of the so-called film, sheet, or plate shape is appropriately used. A material of a curved surface shape in conformity to the curved surface of a medium as well as a flat material is also permitted. Specific examples of the material for the base material A 121 include polyethylene terephthalate (PET), triacetylcellulose (TAC), polycarbonate, polyvinyl chloride, acryl, polyolefin, and glass.

In addition, the thickness of the base material is appropriately selected in accordance with the material, required performance, and the mode according to which the base material is used from the range of about 20 to 5,000 μm, or preferably 100 to 5,000 μm from the viewpoint of curl-preventing performance.

When a product that easily dissolves or swells in a solvent is used as the base material A 121, a barrier layer may be provided on the base material A 121 in order that the substrate A may be unaffected by a solvent in a coating liquid to be used at the time of the printing of the reflection patterns. In this case, the barrier layer may serve also as the orientation film 123. For example, it is sufficient that a water-soluble substance such as polyvinyl alcohol (PVA) or hydroxyethylcellulose (HEC) be used in the barrier layer.

The primer layer 122 may be provided on the base material A 121 of the substrate A 120 according to the present invention as desired (see FIG. 4). Providing the primer layer 122 can strengthen adhesion between the base material A 121 and each of the reflection patterns 110. A primer composition to be used in the primer layer 122 is particularly preferably a transparent resin using, for example, an organic resin or an inorganic resin because the resin can be formed into a layer by application. The resin to be used in the primer composition is not particularly limited, and examples of the resin include a thermoplastic resin, a thermosetting resin, and an ionizing radiation-curable resin. Of those, a resin of such type as to be cured by crosslinking is preferable from the viewpoint of the acquisition of durability, solvent resistance, and a wide reading angle, and the ionizing radiation-curable resin is more preferable because the resin can be crosslinked with ionizing radiation such as an ultraviolet ray or an electron ray within a short time period.

Examples of the thermoplastic resin include an acrylic resin, a polyester resin, a thermoplastic urethane resin, a vinyl acetate-based resin, and a cellulose-based resin. In the case where a material of the substrate A 120 is a cellulose-based resin such as triacetyl cellulose (TAC), as a thermoplastic resin, a cellulose-based resin such as nitrocellulose, acetyl cellulose, cellulose acetate propionate, or ethylhydroxyethyl cellulose is preferred.

Examples of the thermosetting resin include a phenol resin, a urea resin, a diallylphthalate resin, melanin resin, a guanamine resin, an unsaturated polyester resin, a urethane resin, an epoxy resin, an aminoalkyd resin, a melamin-urea co-condensation resin, a silicon resin, a polysiloxane resin, and a curable acrylic resin. In a case where the thermosetting resin is used, as required, a crosslinking agent, a curing agent such as a polymerization initiator, a polymerization promoter, a solvent, a viscosity control agent, or the like may be added.

As a material used in the primer composition, an ionizing radiation curing resin is preferred as described above, various reactive monomers and/or reactive oligomers is preferably used. As the reactive monomer, a polyfunctional (meth)acrylate is exemplified. As the reactive oligomer, an oligomer having a radical-polymerizable unsaturated group in the molecule such as an epoxy (meth)acrylate-based, urethane (meth)acrylate-based, polyester (meth)acrylate-based, and polyether (meth) acrylate-based oligomers may be given. Here, (meth)acrylate refers to acrylate or methacrylate.

In addition, as a polymerization initiator for the reactive monomer or the reactive oligomer, the above-mentioned bisacylphosphine oxide-based or α-aminoketone-based photopolymerization initiator is exemplified.

Examples of the polyfunctional (meth)acrylate monomer include ethylene glycol di(meth)acrylate, propylene glycol di(meth)acrylate, 1,4-butanediol di(meth)acrylate, 1,6-hexanediol di(meth)acrylate, neopentyl glycol di(meth)acrylate, polyethylene glycol di(meth)acrylate, hydroxypivalate neopentyl glycol di(meth)acrylate, dicyclopentanyl di(meth)acrylate, caprolactone-modified dicyclopentenyl di(meth)acrylate, ethyleneoxide-modified phosphate di(meth)acrylate, allylated cyclohexyl di(meth)acrylate, isocyanurate di(meth)acrylate, trimethylolpropane tri(meth)acrylate, ethyleneoxide-modified trimethylolpropane tri(meth)acrylate, dipentaerythritol tri(meth)acrylate, propionate-modified dipentaerythritol tri(meth)acrylate, pentaerythritol tri(meth)acrylate, propyleneoxide-modified trimethylolpropane tri(meth)acrylate, tris(acryloxyethyl)isocyanurate, propionate-modified dipentaerythritol penta(meth)acrylate, dipentaerythritol hexa(meth)acrylate, ethyleneoxide-modified dipentaerythritol hexa(meth)acrylate, and caprolactone-modified dipentaerythritol hexa(meth)acrylate.

In the present invention, a liquid-repellent leveling agent capable of repelling the resin composition as an ink of which each of the reflection patterns 110 is formed may be added into the primer layer 122 as desired in order that the thickness of each of the reflection patterns 110 may be controlled as described above, or, especially, the thickness of each of the reflection patterns 110 may be increased. With regard to the kind of the liquid-repellent leveling agent, various compounds such as silicone-, fluorine-, polyether-, acrylic acid copolymer-, and titanate-based compounds can each be used. The acrylic acid copolymer-based leveling agent (such as a trade name “BYK361” manufactured by BYK-Chemie GmbH) is particularly preferable in order that a resin composition as the ink of a liquid crystal material of which an immobilized cholesteric structure is formed may be repelled. It is sufficient that the addition amount of the leveling agent be appropriately adjusted in accordance with the desired thickness of each of the reflection patterns 110.

In addition, when one wishes to increase the thickness of each of the reflection patterns 110 by using the white pigment composition containing titanium oxide as the above-mentioned preferred embodiment, for example, one desires a thickness of about 6 to 20 μm, the following method can also be selected as one approach: a contact angle between the primer layer 122 and the ink for pattern formation in a liquid state composed of the white pigment composition is increased. In this case, a combination of the materials for both the layer and the ink is selected so that the contact angle between both the layer and the ink may be increased. It should be noted that a liquid-repellent leveling agent is preferably added into the primer layer 122 as in the case of the foregoing when a sufficient contact angle cannot be obtained with the materials for both the layer and the ink themselves. It should be noted that the acrylic acid copolymer-based leveling agent is preferable in the white pigment composition containing titanium oxide as well.

From the viewpoint of the acquisition of a wide reading angle in addition to the provision of each of the reflection patterns 110 with a sufficient thickness, instead of, or in addition to, the addition of the above-mentioned leveling agent (liquid-repellent substance) into the primer layer 122, the following procedure may be adopted: the surface of each of the reflection patterns 110 is curved so as to be a curved surface which is convex upward (such as a hemispherical curved surface), or fine particles are added to the layer so that irregularities or folds are formed on the Bragg reflection surface of the cholesteric structure of a liquid crystal to be formed on the layer. In addition, the fine particles can be added even when the above-mentioned white pigment composition containing titanium oxide is used.

Fine particles to be typically used can be added as the fine particles in an appropriate amount without any particular limitation; for example, spherical particles each made of an inorganic substance such as α-alumina, silica, kaolinite, iron oxide, diamond, or silicon carbide can be used. The shape of each of the particles, which is not particularly limited, is, for example, a spherical shape, an ellipsoidal shape, a polyhedral shape, or a scaly shape; spherical particles are preferable. Fine particles each made of an organic substance are also permitted, and examples of the fine particles include synthetic resin beads each made of, for example, a crosslinked acrylic resin or a polycarbonate resin. Of those materials, α-alumina and silica are preferable because each of α-alumina and silica has high hardness, exerts a large improving effect on the abrasion resistance, and can be easily turned into spherical particles; each of α-alumina and silica is particularly preferably spherical. In addition, the fine particles have an average particle diameter of about 0.01 to 20 μm.

For example, any one of various additives or various dyes in an application liquid or ink may also be appropriately added into the primer layer 122 as required to such an extent that none of the infrared ray-reflecting function and Moire-preventing effect of each of the reflection patterns 110 in the present invention is impaired. Examples of the additives include a light stabilizer such as an ultraviolet ray absorber, and a dispersion stabilizer. Examples of the dyes include known dyes in a filter for display such as a dye for preventing the reflection of ambient light.

The primer layer 122 can be formed of the ink of the primer composition obtained as described above by a known layer formation method such as an application method or a printing method. To be specific, the following procedure has only to be adopted: the ink is formed into the layer on the base material A 121 by the application method such as roll coating, comma coating, or die coating, or the printing method such as screen printing or gravure printing.

It should be noted that the primer layer 122 has a thickness of typically about 0.1 to 10 μm, or preferably 0.1 to 5 μm from the viewpoints of the production of an additionally thin film and the acquisition of an additionally wide reading angle.

In the pattern-printed sheet 11 according to the present invention, the orientation film 123 may be provided on the base material A 121 of the substrate A 120 (see FIG. 5) for the purpose of, for example, stabilizing the orientation of a liquid crystal when a liquid crystal material is used in each of the reflection patterns 110, though the film is not necessarily needed. A material for the orientation film is not particularly limited, and a known orientation film material such as polyimide (PI), polyvinyl alcohol (PVA), hydroxyethylcellulose (HEC), polycarbonate (PC), polystyrene (PS), polymethyl methacrylate (PMMA), polyester (PE), polyvinyl cinnamate (PVCi), polyvinyl carbazole (PVK), polysilane containing cinnamoyl, coumarin, or chalcone can be used. An orientation film formed by using any such material may be subjected to, for example, a rubbing treatment. Alternatively, a stretched resin sheet may be bonded as an orientation film to the base material A 121.

In addition, a surface protective layer composed of a hard coating film for covering the reflection patterns 110 may be provided in the pattern-printed sheet 11 according to the present invention as required. A material for the surface protective layer is not particularly limited, and examples of the material include an acrylic resin, an organic silicon-based resin, and an epoxy resin each cured by crosslinking with, for example, an ultraviolet ray, an electron ray, or heat. Of those, a material having a refractive index close to that of each of the reflection patterns 110 is preferable in order that Moire may be reduced.

Further, an antireflection film or the like may be provided on the surface of, or inside, the pattern-printed sheet 11 according to the present invention in order that the visibility of the screen 10 placed behind the sheet 11 may be secured. A material for the antireflection film is not particularly limited, and, for example, a dielectric multilayer film obtained by laminating a thin film made of a substance having a low refractive index such as magnesium fluoride or a fluorine-based resin and a thin film made of a high refractive index such as zirconium oxide or titanium oxide so that the thin film having a low refractive index serves as the outermost surface can be used.

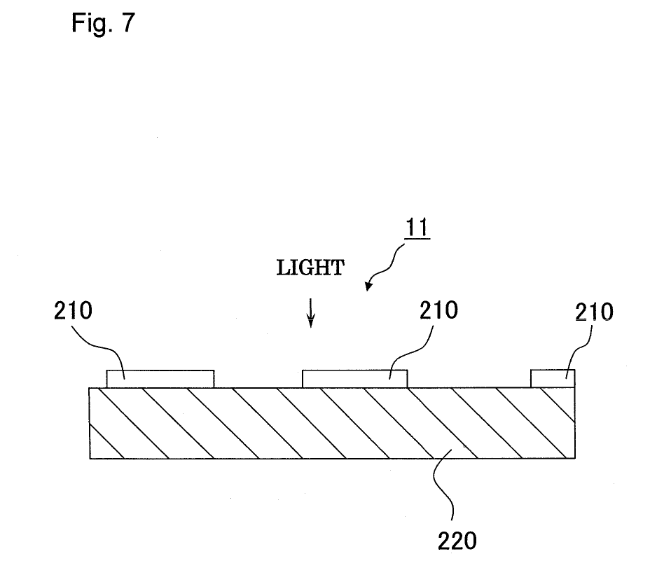

FIGS. 7 to 11 are sectional views showing one and other embodiments of the pattern-printed sheet 11 having the absorption patterns 210 to be used in the image projection system of the present invention.

As shown in FIG. 7, the pattern-printed sheet 11 having the absorption patterns 210 is preferably obtained by providing the absorption patterns on a substrate B 220 which diffuses and reflects invisible light rays according to any one of the above-mentioned arrangements by printing and applying means such as gravure printing.

Specific shapes of the pattern-printed sheet 11 having the absorption patterns according to the present invention include the following shapes (1-A), (1-B), and (2):

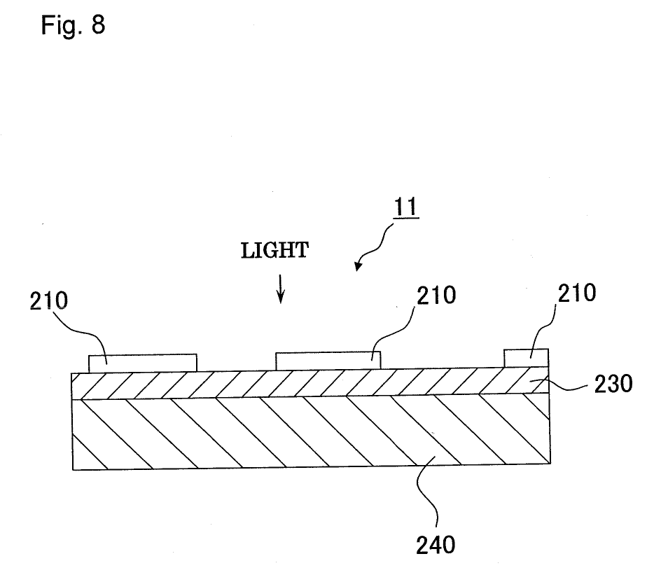

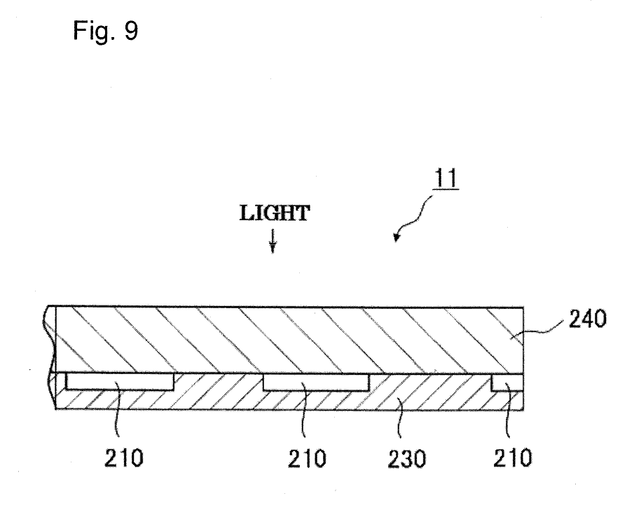

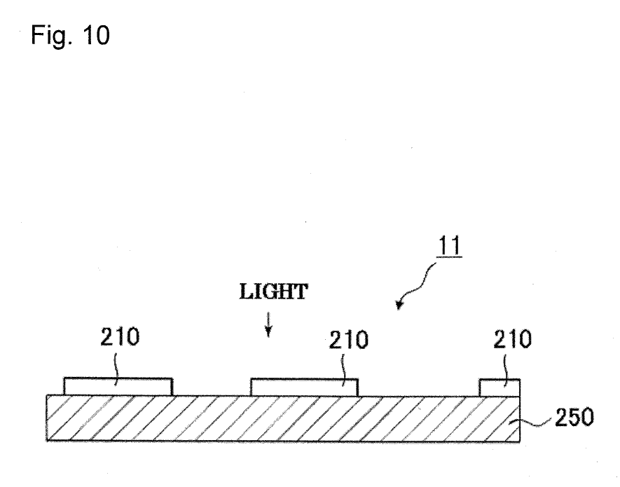

(1-A): the pattern-printed sheet 11 is such that, as shown in FIG. 8, a curved liquid crystal layer 230 composed of a liquid crystal material having a cholesteric structure which diffuses and reflects invisible light rays is provided on a transparent base material 240 so that the substrate B 220 is formed, and the absorption patterns 210 are printed on the substrate;
(1-B): the pattern-printed sheet 11 (1-B) is such that, as shown in FIG. 9, the absorption patterns 210 are printed on the transparent base material 10, the curved liquid crystal layer 230 composed of a liquid crystal material having a cholesteric structure which diffuses and reflects invisible light rays is provided on the resultant, and, in this case as well, a combination of the transparent base material 240 and the liquid crystal layer 230 serves as the substrate B 220; and
(2): the pattern-printed sheet 11 is such that, as shown in FIG. 10, a light diffusion film 250 for diffusing invisible light rays is used as the substrate B 220, and the absorption patterns 210 are printed on one surface of the light diffusion film 250.

In each of the shapes (1-A), (1-B), and (2) of the pattern-printed sheet 11 having the absorption patterns according to the present invention, an infrared ray-absorbing material to be used in each of the absorption patterns 210 is not particularly limited; one kind of organic near infrared ray-absorbing dyes such as polymethine-based compounds, cyanine-based compounds, phthalocyanine-based compounds, naphthalocyanine-based compounds, naphthoquinone-based compounds, anthraquinone-based compounds, immonium-based compounds, diimmonium-based compounds, aminium-based compounds, pyrylium-based compounds, cerylium-based compounds, squarylium-based compounds, copper complexes, nickel complexes, and dithiol-based metal complexes, and inorganic near infrared ray-absorbing dyes composed of fine particles of, for example, carbon black, tin oxide, indium oxide, tungsten hexachloride, aluminum oxide, zinc oxide, iron oxide, and a cesium-tungsten-based composite oxide (Cs_{0.33}WO₃) can be used, or two or more kinds of the organic and inorganic near infrared ray-absorbing dyes can be used in combination.

In addition, an ultraviolet ray-absorbing material which is not particularly limited, is, for example, an inorganic or organic ultraviolet ray absorber, and is preferably the organic ultraviolet ray absorber. Of the organic ultraviolet ray absorbers, for example, a benzotriazole-, benzophenone-, or salicylate-based ultraviolet ray absorber is preferably used. In addition, out of the inorganic ultraviolet ray absorbers, for example, fine particles each made of titanium oxide, cerium oxide, zinc oxide, or the like are preferably used.

In addition, a binder resin to be used together with each of the infrared ray-absorbing material and the ultraviolet ray-reflecting material is the same resin as the binder resin of the resin composition for an ink of which each of the reflection patterns 110 is formed, and examples of the binder resin include a polyester resin, a urethane resin, an acrylic resin, an epoxy resin, a vinyl chloride-vinyl acetate copolymer, and a mixture of two or more kinds selected from them.

It should be noted that the invisible light ray-absorbing material is not necessarily requested to show a high transmittance for light having a wavelength in the visible light ray region in essence as long as the material shows a high absorptivity for light having a wavelength in at least part of the invisible light ray region (about 50% or more in ordinary cases); provided that it is of course preferable that the invisible light ray-absorbing material itself have a high visible light ray transmittance.

In each of the shapes (1-A) and (1-B), the term “curved liquid crystal layer 230 composed of a liquid crystal material having a cholesteric structure (which may hereinafter be referred to as “cholesteric liquid crystal material”)” refers to such layer structure as described below: the layer is formed so as to include a multilayer structure having a certain cycle period when the section of the formed layer cut along a surface perpendicular to the substrate B 220 (composed of the liquid crystal layer 230 and the transparent base material 240 in each of FIGS. 8 and 9) is observed with a scanning electron microscope, and at least part of each layer surface of the multilayer structure is curved to form a non-flat plane. In addition, a tilt angle formed between the helical axis (see the following definition, the axis is perpendicular to the layer surface) of the liquid crystal material of which the multilayer structure is constituted and the normal of the surface of the transparent substrate preferably has a distribution in the range of at least 0 to 45°.

Here, the liquid crystal having a cholesteric (chiral nematic) structure is the same as that used in each of the reflection patterns 110, and, as in the case of the foregoing, the addition of a chiral agent to a liquid crystalline monomer showing a nematic liquid crystal phase results in a chiral nematic liquid crystal (cholesteric liquid crystal). Examples of the nematic liquid crystal molecule (liquid crystalline monomer) that can be used include the compounds represented by the above formulae (1) to (11). Those described above are used for the crosslinkable polymerizable oligomer, the liquid crystal polymer, the chiral agent, any other compounding agent, the solvent, the leveling agent, the fine particles, and the like as well. Examples of the chiral agent include compounds each represented by the above formula (12).

The transparent base material B 240 to be used in each of the shapes (1-A) and (1-B) of the pattern-printed sheet 11 having the absorption patterns 210 according to the present invention, which may be formed of an arbitrary material without any particular limitation as long as the material transmits visible light, is preferably formed of a material having a small number of optical discrepancies; a product of the so-called film, sheet, or plate shape is appropriately used. To be specific, glass, triacetylcellulose (TAC), polyethylene terephthalate (PET), polycarbonate, polyvinyl chloride, acryl, polyolefin, or the like is suitably used as a material for the transparent base material B 240. In addition, the thickness of the base material is appropriately selected in accordance with the material, required performance, and the mode according to which the base material is used from the range of about 20 to 5,000 μm.

When a product that easily dissolves or swells in a solvent such as a polymer film, for example, a TAC film is used as the transparent base material B 240, the above-mentioned barrier layer is preferably provided on the base material in the same manner as that at the time of the printing of the reflection patterns in order that the base material may be unaffected by a solvent in a coating liquid to be used at the time of the printing of the absorption patterns.

In the pattern-printed sheet 11 having the absorption patterns 210 according to the present invention, an orientation film may be provided on the transparent base material B 240 for the purpose of, for example, stabilizing the orientation of the liquid crystal of the liquid crystal layer 230, though the film is not necessarily needed. A material for the orientation film is not particularly limited, and a known orientation film material such as polyimide (PI), polyvinyl alcohol (PVA), hydroxyethylcellulose (HEC), polycarbonate (PC), polystyrene (PS), polymethyl methacrylate (PMMA), polyester (PE), polyvinyl cinnamate (PVCi), polyvinyl carbazole (PVK), polysilane containing cinnamoyl, coumarin, or chalcone can be used. An orientation film formed by using any such material may be subjected to, for example, a rubbing treatment. Alternatively, a stretched resin sheet may be bonded as an orientation film to the transparent base material. A material for the orientation film is as described above.

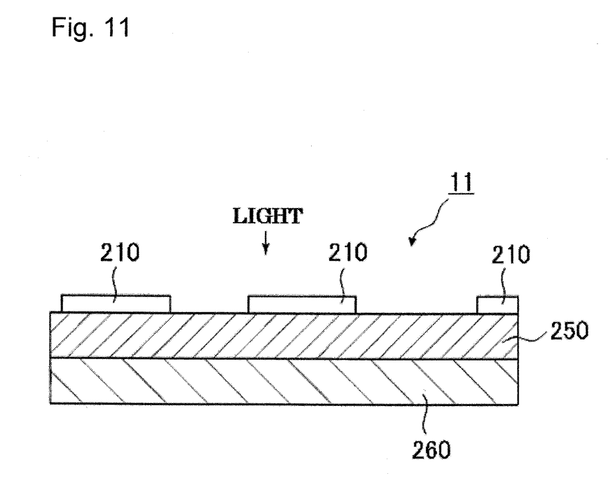

In the shape (2) of the pattern-printed sheet 11 having the absorption patterns 210 according to the present invention, it is preferable that the absorption patterns 210 be printed on one surface of the light diffusion film 250 for diffusing invisible light rays, and an invisible light ray-reflecting layer 260 be formed on the other surface of the film (see FIG. 11). In this case, the light diffusion film 250 and the invisible light ray-reflecting layer 260 form the substrate B 220.

In the shape (2), the light diffusion film 250 for diffusing invisible light rays is a film having the following property: the film diffuses and transmits, diffuses and reflects, or not only diffuses and reflects but also diffuses and transmits incident light rays. Representative examples of the film include a film obtained by dispersing and incorporating transparent fine particles or colored fine particles in a plastic film so that light can be scattered, and a film obtained by roughening the surface of the plastic film so that light can be scattered. The plastic film is not particularly limited, and examples of the film include films each made of, for example, polyethylene terephthalate, polycarbonate, or acryl.

Alternatively, for example, a method of causing a superimposed body of birefringent films obtained by dispersing and distributing minute regions different from each other in birefringent characteristic to scatter light by utilizing a difference in refractive index between each of the birefringent films and each of the minute regions (Japanese Patent Application Laid-open No. Hei 11-174211), or a polymer film in which microcrystalline regions composed of the same polymer are dispersed and distributed, and which shows light-scattering property by virtue of a difference in refractive index between each of the microcrystalline regions and any other portion (Japanese Patent Application Laid-open No. Hei 11-326610, Japanese Patent Application Laid-open No. 2000-266936, Japanese Patent Application Laid-open No. 2000-275437, or the like) can also be employed.

Further, a diffusion lens film having such a function that light rays are diffused by a fine irregular shape on the surface of the film after having been converged once is also useful as the light diffusion film 250.

In the shape (2), the light diffusion film 250 may be a layer having retroreflective performance. In this case, for example, such a shape that a layer having retroreflective performance is provided on one surface of the transparent base material B 240, and absorption patterns are printed on the other surface of the base material is preferable.

It should be noted that a retroreflective material to be used in the layer having retroreflective performance is such a material as described below: a large number of minute, highly refractive glass beads each serving as a lens and each having a diameter of 40 to 90 μm are placed in a binder resin so as to satisfy a certain effect, and each of the beads is of a completely spherical shape to act as one kind of a convex lens so that incident light rays pass through the glass bodies to be refracted to come into a focus on one point, but a reflecting layer is provided on the bottom portion of each sphere so that the rays pass through the glass bodies again to return toward the original light source.

Examples of the invisible light ray-reflecting layer 260 in the shape (2) include: (a) a coating film of each of a liquid crystal material for the reflection patterns 110 and the cholesteric liquid crystal material described in each of the shapes (1-A) and (1-B); (b) a coating film containing a metal oxide the particle diameter of which is smaller than the wavelength of an incident light ray; (c) a dielectric multilayer film which is obtained by alternately laminating a low-refractive-index layer and a high-refractive-index layer having a higher refractive index than that of the low-refractive-index layer, and in which the high-refractive-index layer is positioned at the outermost surface on a reading side; and (d) an invisible light ray-reflecting film.

Examples of (b) the metal oxide include metal oxides to be used as the infrared ray-reflecting material and the ultraviolet ray-reflecting material described above.

A material in (c) the dielectric multilayer film obtained by alternately laminating a low-refractive-index layer and a high-refractive-index layer having a higher refractive index than that of the low-refractive-index layer is, for example, any one of the inorganic materials and the resin-based materials; a material showing a desired low or high refractive index at the wavelength of an invisible light ray to be used in the reading of the patterns can be selected and used.

The inorganic materials can be roughly classified into a material for a low-refractive-index layer A and a material for a high-refractive-index layer B.

A material having a refractive index of 1.6 or less can be typically used as the inorganic material of which the low-refractive-index layer A is formed; a material having a refractive index in the range of 1.2 to 1.6 is preferably selected.

Examples of such materials include silica, alumina, lanthanum fluoride, magnesium fluoride, and sodium hexafluoroaluminate.

In addition, a material having a refractive index of 1.7 or more can be used as the inorganic material of which the high-refractive-index layer B is formed; a material having a refractive index in the range of 1.7 to 2.5 is preferably selected.

Examples of the material include a material containing, as a main component, titanium oxide, zirconium oxide, tantalum pentoxide, niobium pentoxide, lanthanum oxide, yttrium oxide, zinc oxide, zinc sulfate, or indium oxide, and containing a small amount of titanium oxide, tin oxide, cerium oxide, or the like.

It should be noted that the inorganic materials are not limited to low- and high-refractive-index materials because the low-refractive-index layer and the high-refractive-index layer are determined on the basis of a relative refractive index. In addition, each of the materials described in Japanese Examined Patent Publication No. Sho 61-51762, Japanese Patent Application Laid-open No. Hei 03-218822, and Japanese Patent Application Laid-open No. Hei 03-178430 can also be appropriately used.

A method of laminating the low-refractive-index layer A and the high-refractive-index layer B by using such inorganic materials as described above is not particularly limited as long as a dielectric multilayer structure is formed by laminating the layers of these materials; the multilayer structure can be formed by alternately laminating the low-refractive-index layer A and the high-refractive-index layer B by, for example, a CVD method, a sputtering method, a vacuum deposition method, or wet coating.

Specific examples of the resin-based material in the dielectric multilayer include polyethylene naphthalate (PEN) and isomers thereof (such as 2,6-, 1,4-, 1,5-, 2,7-, and 2,3-PEN), polyalkylene terephthalate (such as polyethylene terephthalate (PET), polybutylene terephthalate (PBT), poly-1,4-cyclohexanedimethylene terephthalate), PETG, and copolymers thereof, polyimides (for example, polyacryl imide), polyether imide, polycarbonates (including, for example, a copolymer such as a copolycarbonate of 4,4′-thiodiphenol and bisphenol A at a molar ratio of 3:1), polymethacrylate (for example, polyisobutyl methacrylate, polypropyl methacrylate, polyethyl methacrylate, and polymethyl methacrylate), polyacrylates (for example, polybutyl acrylate and polymethyl acryalate), atactic polystyrene, syndiotactic polystyrene (SPS), syndiotactic polyalphamethyl styrene, syndiotactic polydichlorostyrene, copolymers or a blended substance of any one of those polystyrenes, cellulose derivatives (for example, ethylcellulose, acetylcellulose, cellulose propionate, acetylcellulosebutyrate and cellulose nitrate), polyalkylene polymers (such as polyethylene, polypropylene, polybutylene, polyisobutylene, and poly(4-methyl)pentene), fluolopolymers (for example, a perfluoroalkoxy resin, polytetrafluoroethylene, a fluoroethylene propylene copolymer, fluoropolyvinylidene, and polychloro trifluoroethylene), chlorinated polymers (for example, polyvinylidene chloride and polyvinylchloride), polysulfone, polyether sulfone, polyacrylonitrile, polyamide, a silicone resin, an epoxy resin, polyvinyl acetate, polyetheramide, an ionomer resin, elastomers (for example, polybutadiene, polyisoprene, and neoprene), and polyurethane.

Further, examples of the copolymer include PEN copolymers (for example, 2,6-, 1,4-, 1,5-, 2,7-, and 2,3-naphthalene dicarboxylic acids or esters thereof such as a copolymer of a combination selected from (a) terephthalic acid or its esters, (b) isophthalic acid or its esters, (c) phthalic acid or its esters, (d) alkane glycol, (e) cycloalkane glycol (for example, cyclohexane dimethanol diol), (f) alkane dicarboxylic acid, and (g) cycloalkane dicarboxylic acid (for example, cyclohexane dicarboxylic acid)), a copolymer of polyalkylene terephthalate (for example, terephthalic acid or its esters such as a copolymer of a combination selected from (a) naphthalene dicarboxylic acid or its esters, (b) isophthalic acid or its esters, (c) phthalic acid or its esters, (d) alkane glycol, (e) cycloalkane glycol (for example, cyclohexane dimethane diol), (f) alkane dicarboxylic acid, and (g) cycloalkane dicarboxylic acid (for example, cyclohexane dicarboxylic acid)), styrene copolymers (for example, a styrene butadiene copolymer and a styrene acrylonitrile copolymer), and 4,4′-bibenzoic acid, and ethylene glycol.

In addition, each of the layers of the dielectric multilayer film may contain a blend of two or more kinds of the above-mentioned polymers or copolymers (such as a blend of syndiotactic polystyrene (SPS) and atactic polystyrene).

Alternatively, each of the high-refractive-index layer B and the low-refractive-index layer A may use a mixture of two or more kinds of those polymers.

Further, the following procedure may be adopted: each layer is formed by using, for example, a monomer or oligomer which cures with light, ionizing radiation, heat, or the like, and is then cured. When the polymer, oligomer, or monomer of which each layer is formed is soluble in a solvent, a solution of the polymer, oligomer, or monomer may be applied and dried.

A combination of the above resin-based materials to be used in the high-refractive-index layer B and the low-refractive-index layer A is, for example, as follows: polyethylene-2,6-naphthalate can be used in the high-refractive-index layer B, and polyethylene terephthalate can be used in the low-refractive-index layer A.

A method of laminating the low-refractive-index layer A and the high-refractive-index layer B by using such resin-based materials as described above is not particularly limited as long as the selection of these materials leads to the formation of the low-refractive-index layer A and the high-refractive-index layer B; examples of the method include co-extrusion (simultaneous extrusion), hot-melt coating, the thermocompression bonding of a thin-layer sheet, coating, and wet coating. Of those, simultaneous extrusion of two kinds of materials having similar rheology characteristics (such as a melt viscosity) is preferable if possible. Multilayer coating or the like is also suitable when a material capable of curing with an ultraviolet ray or ionizing radiation is used.

The multilayer structure shows a larger reflecting action as the number of laminated layers increases. Accordingly, the number of repeating units, i.e., layers is preferably ten or more. However, an excessive increase in the number of laminated layers not only increases the number of steps for the production of the multilayer structure but also enlarges a step difference between a concave and a convex from the base material, so the number is preferably reduced to such an extent possible that light reflected from the multilayer structure can be detected with an invisible light ray sensor. The number of laminated layers is in the range of typically 10 to 80, preferably 25 to 50. The thickness of the multilayer structure, which is not particularly limited as long as the thickness is adjusted so that an incident invisible light ray can be reflected, is preferably 50 to 200 μm.

Alternatively, in the shape (2), a transparent base material similar to that of each of the shapes (1-A) and (1-B) may be further provided on the invisible light ray-reflecting layer 260.

An example of (d) the invisible light ray-reflecting film is a multilayer film obtained by sputtering an ultrathin film onto a polyester film.

A method of printing each of the reflection patterns 110 and the absorption patterns 210 in the pattern-printed sheet 11 according to the present invention is not particularly limited, and a known method can be employed. Examples of the method include a flexographic printing method, a gravure printing method, a stencil printing method, and an ink-jet printing method.

### EXAMPLES

Next, a production example of the pattern-printed sheet 11 and an example of the present invention using the sheet will be described.

### Production Example 1

The following components were uniformly kneaded and dispersed, whereby an ink A for the formation of reflection patterns was prepared.

| | |
|---|---|
| Polyurethane-based resin (trade name “Urearnou | 40.0 parts by weight |
| 2466” manufactured by Arakawa Chemical | |
| Industries, Ltd.): | |
| Nitrocellulose: | 2.0 parts by weight |
| Curing agent (trade name “TAKENATE D-110N” | 4.0 parts by weight |
| manufactured by MITSUI CHEMICALS | |
| POLYURETHANES, INC.): | |
| Isopropyl alcohol: | 5.0 parts by weight |
| Methyl ethyl ketone: | 6.0 parts by weight |
| Ethyl acetate: | 4.0 parts by weight |
| Titanium oxide: | 39.0 parts by weight |
| (surface-treated with silica, average particle | |
| diameter: 0.3 μm) | |

Next, the upper portion of the base material A 121 having a thickness of 125 μm and composed of polyethylene terephthalate (PET) was coated with a solution prepared by dissolving, in methyl ethyl ketone (MEK), 100 parts by weight of pentaerythritol triacrylate, 0.03 part by weight of an acrylic acid copolymer-based leveling agent (trade name “BYK361” manufactured by BYK-Chemie GmbH), and 4 parts by weight of a polymerization initiator (trade name: Lucirin TPO, manufactured by BASF) by using a bar coater, and the solution was dried at 80° C. for 2 minutes, whereby the primer layer 122 having a thickness of 1 μm was formed. Thus, the substrate A 120 was obtained.

The above ink A for the formation of reflection patterns was applied onto the primer layer 122 of the substrate A 120 by a gravure printing method so as to be of dot shapes arranged as shown in FIG. 3. The ink was cured with heat, whereby the pattern-printed sheet 11 was obtained. The resultant pattern-printed sheet 11 was irradiated with an infrared ray, and a dot pattern which reflected the infrared ray was detected as an image with a sensor by detecting reflected light from the dot pattern. As a result, the sheet was found to have a wide reading angle; the sensor was able to read light reflected at an angle up to 40°.

### Production Example 2

A solution was prepared by dissolving, in methyl isobutyl ketone (MIBK), 100 parts by weight of a monomer having a polymerizable acryloyl group at any one of its terminals and having a nematic-isotropic transition temperature around 110° C. (having a molecular structure represented by the chemical formula (9)), 3.0 parts by weight of a chiral agent having a polymerizable acryloyl group at any one of its terminals (having a molecular structure represented by the chemical formula (12)), and 4 parts by weight of a photopolymerization initiator diphenyl-(2,4,6-trimethylbenzoyl)phosphine oxide (trade name: Lucirin TPO, manufactured by BASF), and the solution was defined as an ink B for the formation of reflection patterns.

Next, the primer layer 122 having a thickness of 1 μm was formed on the same base material A 121 as that of Production Example 1 in the same manner as in Production Example 1. Thus, the substrate A 120 was obtained.

The above ink B for the formation of reflection patterns was applied onto the primer layer 122 of the substrate A 120 by a gravure printing method so as to be of dot shapes arranged as shown in FIG. 3. The ink was cured with heat, whereby the pattern-printed sheet 11 was obtained. The resultant pattern-printed sheet 11 was irradiated with an infrared ray, and a dot pattern which reflected the infrared ray was detected as an image with a sensor by detecting reflected light from the dot pattern. As a result, the sheet was found to have a wide reading angle; the sensor was able to read light reflected at an angle up to 40°.

### Production Example 3

An infrared ray-reflecting ink was prepared by dissolving, in methyl isobutyl ketone, 100 parts by weight of a monomer having a polymerizable acryloyl group at any one of its terminals and having a nematic-isotropic transition temperature around 110° C. (having a molecular structure represented by the compound (11)), 3.0 parts by weight of a chiral agent having a polymerizable acryloyl group at any one of its terminals (having a molecular structure represented by the above chemical formula (12)), 4 parts by weight of a photopolymerization initiator (Lucirin TPO manufactured by BASF), and 0.3 part by weight of a leveling agent (BYK361 manufactured by BYK-Chemie GmbH).

The liquid crystal solution was directly applied onto the transparent base material B 240 having a thickness of 125 μm and composed of PET by a gravure printing method, and was cured by being irradiated with an ultraviolet ray, whereby the infrared ray-diffusing-and-reflecting substrate B 220 was produced.

Next, an infrared ray-absorbing ink was prepared by dissolving, in cyclohexanone, 100 parts by weight of pentaerythritol triacrylate, 2 parts by weight of a phthalocyanine-based dye (IR-12 manufactured by NIPPON SHOKUBAI CO., LTD.), and 4 parts by weight of a photopolymerization initiator (Lucirin TPO manufactured by BASF) Dot-shaped patterns each formed of the infrared ray-absorbing ink were printed on the substrate B 220 by gravure printing, whereby the pattern-printed sheet 11 was obtained. The resultant pattern-printed sheet 11 was irradiated with an infrared ray, and a dot pattern which absorbed the infrared ray was detected as an image with a sensor by detecting reflected light from the place other than the dot pattern which absorbs the infrared ray. As a result, the sheet was found to have a wide reading angle; the sensor was able to read light reflected at an angle up to 40°.

### Production Example 4

An infrared ray-reflecting film (Reftel WH03 manufactured by Teijin Limited) was bonded to one surface of a diffusion lens film (in other words, the light diffusion film 250, LCD80PC10-F100 manufactured by Optical Solutions Corporation), whereby the infrared ray-reflecting layer 260 was formed.

Dot-shaped patterns each formed of the infrared ray-absorbing ink prepared in Production Example 3 were printed on the other surface of the diffusion lens film, whereby the pattern-printed sheet 11 was obtained. The resultant pattern-printed sheet 11 was irradiated with an infrared ray, and a dot pattern which absorbed the infrared ray was detected as an image with a sensor by detecting reflected light from the place other than the dot pattern which absorbs the infrared ray. As a result, the sheet was found to have a wide reading angle; the sensor was able to read light reflected at an angle up to 40°.

### Production Example 5

A solution prepared by diluting a retroreflective material (Art Bright Color manufactured by Komatsu Process Corporation) with cyclohexanone to have a solid content of 30% was applied onto the transparent base material B 240 having a thickness of 125 μm and composed of PET, whereby the infrared ray-reflecting layer 260 was formed. The same infrared ray-absorbing dots as those of Production Example 3 were formed on the other surface of the transparent base material B 240 composed of PET, whereby the pattern-printed sheet 11 was obtained. The resultant pattern-printed sheet 11 was irradiated with an infrared ray, and a dot pattern which absorbed the infrared ray was detected as an image with a sensor by detecting reflected light from the place other than the dot pattern which absorbs the infrared ray. As a result, the sheet was found to have a wide reading angle; the sensor was able to read light reflected at an angle up to 40°.

### Example 1

Evaluation for pattern reading in the image projection system of the present invention including the input terminal 20 provided with an infrared ray-applying portion was performed by using each of the pattern-printed sheets 11 obtained in Production Examples 1 to 5. As a result, each of the pattern printed sheets 11 neither failed to read nor made an error in recognizing positional information (coordinates), and was able to perform reading at a sufficient signal level. As a result, it became possible to input the positional information of the screen simply in a non-contact fashion with high accuracy.

In addition, when the image projection system of the present invention was operated by using each of the pattern-printed sheets 11 obtained in Production Examples 1 to 5, the following phenomenon was attained: the image information A converted from positional information input by handwriting was further converted into visible light rays, and the rays were projected with high accuracy. In addition, when the image information B as a moving image and the image information A were combined so as to be converted into composite image information by using an image source unit, the projection of the composite image information as continuous streaming information was attained.

### INDUSTRIAL APPLICABILITY

As described above in detail, the image projection system of the present invention is suitably used in, for example, imaging applications, presentation in conference rooms, and the projection of various contents in various places such as a hotel, a museum, a government office, a corporation, and a household.

1: An image projection system, comprising:
a screen;
an input terminal;
an image processing unit;
an image projector; and
invisible light ray-shielding means,
characterized in that:
the screen has a pattern-printed sheet having reflection patterns for transmitting positional information by reflecting invisible light rays or absorption patterns for transmitting positional information by absorbing invisible light rays;
the input terminal has an invisible light ray-applying portion, detects a reflected light ray of an invisible light ray, which is applied from the invisible light ray-applying portion and reflected from a specific site of the pattern-printed sheet, reads positional information of any one of the reflection patterns or any one of the absorption patterns, and outputs the positional information to the image processing unit;
the image processing unit converts the positional information input from the input terminal into image information A, and transfers the image information A to the image projector;
the image projector converts the image information A transferred from the image processing unit into visible light rays, and projects the visible light rays on the screen; and
the invisible light ray-shielding means is placed in front of or inside the image projector, and removes the invisible light ray from the visible light rays to be projected.

2: An image projection system according to claim 1, wherein:
the image projection system further comprises an image source unit for reading and transferring image data; and
the image processing unit converts the positional information into the image information A, and converts the image data transferred from the image source unit into image information B.

3: An image projection system according to claim 2, wherein the image processing unit converts the image data into the image information B in accordance with a command of the image information A.

4: An image projection system according to claim 2, wherein the image processing unit compounds the image information A and the image information B into composite image information.

5: An image projection system according to claim 2, wherein the image information A and/or the image information B each comprise/comprises streaming information.

6: An image projection system according to claim 1, wherein the pattern-printed sheet is obtained by arranging the reflection patterns on a substrate that transmits an invisible light ray.

7: An image projection system according to claim 1, wherein the reflection patterns are each of a dot shape.

8: An image projection system according to claim 1, wherein the reflection patterns are each composed of a resin composition in which titanium oxide is dispersed and incorporated.

9: An image projection system according to claim 8, wherein the resin composition comprises a urethane resin composition.

10: An image projection system according to claim 1, wherein the pattern-printed sheet is obtained by arranging the absorption patterns on a substrate that diffuses and reflects an invisible light ray.

11: An image projection system according to claim 10, wherein the absorption patterns are each of a dot shape.
